(19) United States
(12) Patent Application Publication
(10) Pub. No.: US 2022/0108625 A1
(43) Pub. Date: Apr. 7, 2022

(54) Teaching Of An Advanced Narrowly-Defined Mechanical-Physics-Based Science And Its Applications

(71) Applicant: Josef Hengko Tsau, Arlington Heghts, IL (US)

(72) Inventor: Josef Hengko Tsau, Arlington Heghts, IL (US)

(21) Appl. No.: 17/063,405

(22) Filed: Oct. 5, 2020

(51) Int. Cl. G09B 19/00

(52) U.S. Cl. CPC G09B 19/00

(57) ABSTRACT

The invention relates to the belief that science needs to have a specific definition to obey with and the finding of a simple specific definition of science of “using experimental methods to discover nature laws and to prove them correct or wrong”, which can interpret a portion of the well-established mechanical-physics-based science (MPS) and its technological applications leading to the discovery of the teaching of an advanced MPS and its technological applications obeying this narrow definition of science (NMPSA). The inventive advanced NMPSA unexpectedly teaches a science broadly covering everything detectable experimentally but it is incompatible with today's worldwide accepted science and therefore is highly unexpected and is unacceptable to the scientific community as correct science and correct technological applications.

### BACKGROUND OF THE INVENTION

Historically, academic scientists have long gotten out religious control and enjoyed great academic freedom to conduct scientific R&D without having a specific definition of science to follow to come up with today's science combining MPS with the mainstream-of-thought physics (MTP) also known as modern physics mainly including Einstein's theories of relativity, quantum theory, and big bang theory. Both Copernicus and Galileo during 16-17 Centuries have led to the development of MPS, which has been considered well established by the end of 19^{th} Century. Yet, in 20^{th} Century it has been found incapable of interpreting the newly discovered relativistic phenomena and quantum phenomena leading to the development of MTP. Ever since, great effort and progress have been made in the R&D of MTP leading the scientific community worldwide to accept MTP as another core-physics based science besides MPS. Now, MTP has been broadly used to interpret most important scientific topics such as universal phenomena, universe, particle physics, cosmology, and astronomy at the expense of MPS, which has been considered incapable of and unacceptable to also interpret these same scientific topics despite that it is still the daily applied science.

It has taken a scientific revolution known to be Einstein's scientific revolution over a century long to develop MTP facing strong oppositions to defend MPS. The success of the scientific revolution has led the scientific community worldwide to consider MPS incapable and unacceptable for use to interpret the above-mentioned important scientific topics. Taking the inventor's experience for example, his MPS-based research papers had been repeatedly rejected for publication by scientific journals and his scientific proposals to National Science Foundation for funding have also been repeatedly rejected leaving him to conduct his R&D by himself alone. Over the past two decades he has written several “publishing on demand” books marketing through Internet to report the progresses of his MPS R&D with the latest book entitled “The Beautiful Mechanical Universe” published in 2014 by Lulu Publishing Services. However, since these publications are not recognized by the authorities of the scientific community and the governments, which require peer review and/or editorial refereeing processes to confine scientific content agree with their accepted MTP-based knowledge, only very few of his books have been sold without getting any scientific comments and attention from the scientific community, the governments, and even the general public. He has also published a website entitled scientificrevolution.org for several years resulted in having the same fate.

Only recently, the inventor has realized that his invention is based on the above-mentioned narrow definition of MPS, which neither covers the entire MPS, such as Newton's gravity theory, nor is compatible with MTP. Not intending to judge the correctness of today's worldwide accepted science and its interpretation of technological applications, the inventive NMPSA intends to be correct science having correct technological applications covering a narrow range of science only but it resulted in having a broad scope covering everything detectable experimentally. Since only the correct science can have such a broad scope, the invention is highly unexpected and it has unintentionally raised the serious question what exactly the real or correct science is for the world, particularly the scientific community, to find the answer.

Today's science teaches that both proton and electron are tiny point particles made of quarks and glues and therefore matter made of them is essentially vacuum space and that the atmospheric neutrino particles discovered over half century ago penetrate through matter freely without having significant collision interactions with it to produce any composition of matter or any universal phenomena.

### SUMMARY OF THE INVENTION

The invention relates to obey a simple, clear, and specific definition of science of “using experimental methods to discover nature laws and to prove them correct or wrong” to narrowly define MPS its technological applications (NMPSA), such as the kinetics-based MPS, to limit science to study only matter, the only thing experimentally detectable. The inventive definition of science is so narrow or specific, it even excludes Newton's gravity theory, since without having matter particle in space to produce Newton's gravitational force, it should not be detectable experimentally in space. The inventive NMPSA also does not include MTP for the same reason, since, for example, Einstein's gravity theory also has no matter particle in space to produce gravitational force. The invention therefore is not acceptable to the scientific community as correct science. Yet, it unexpectedly can interpret everything detectable experimentally logically, consistently, and coherently as a whole. For example, it also interprets those scientific topics already interpreted by MTP accepted by the scientific community as the correct science but having different scientific interpretations and technological applications. The invention therefore regards to the teaching of a science and its technological applications different from what we have learnt and what students are learning in schools and in universities.

### DETAILED DESCRIPTION OF THE INVENTION

The invention relates to obeying a definition of science to narrowly define MPS and to interpret its applications (NMPSA) excluding Newton's theory of gravity, the wave theories of light, and MTP. It is highly unexpected that the invention can teach all scientific topics and their applications different from what we have learnt and are learning in schools and universities.

It begins with the realization that for a proton and an electron to constantly carry charge energy, they must have a composite system of a single uncharged proton particle or a single uncharged electron particle surrounded by a dense cloud of neutrino particles to become efficient enough to collide interacting with the atmospheric energetic neutrino particles to constantly gain their kinetic energy converting it to their own charge energy. In space, such a composite system carrying charge energy should become a low-energy center and the atmospheric energetic neutrino particles should have a pushing force toward it from all directions. Besides, under constant bombardment of atmospheric energetic neutrino particles, their dense cloud of neutrino particles should have a pushing force outward. Therefore, the charge energy of such a composite system is expressed by its two opposite forces and its unique size. Having charge energy allows protons and electrons to form matter of different compositions meaning that proton, electron and the matter made of them such as the matter having atomic and molecular structures also contain dense clouds of neutrino particles to be dense enough to allow the collective collision interactions of matter with the atmospheric energetic neutrino particles to be effective enough to produce different compositions of matter and their universal phenomena. The invention therefore teaches that different compositions of matter made of protons and electrons and their universal phenomena are produced by their collision interactions with atmospheric energetic neutrino particles. Therefore, universal forces are the pushing force of the atmospheric neutrino particles such as that the gravitational force of the invention is the pushing force of the wind of the atmospheric neutrino particles constantly blowing into the heavenly bodies consisting of matter having atomic and molecular structures. It further teaches that the inventive elementary particles to make different compositions of matter and to produce universal phenomena are the single uncharged particle of protons, the single uncharged particle of electrons, and the neutrino particles. They are the three size-range groups of the matter particles constantly produced and emitted by the nuclear reactions of all stars. The invention further divides the elementary neutrino particle size-range group into two, the neutrino-particle size-range group and the mini-neutrino-particle size-range group having even much smaller particle sizes than the neutrino-particle size-range group, and teaches that, like both electrons and protons, all uncharged neutrino particles are surrounded by a dense cloud of mini-neutrino particles, thus, to carry mini-charge energy and only in a special environment of “inside the dense clouds of the electrons inside matter under constant bombardment of the atmospheric energetic neutrino and mini-neutrino particles” mini-atoms and mini-molecules are formed among mini-charged neutrino particles of different sizes, which are the inventive light (and heat) particles. Therefore, only matter such as the matter having atomic and molecules structures emit light; the collision interactions of matter particles in physical, chemical, and nuclear reactions emit or absorb light particles; and light spectra are quantized.

The invention further relates the scientific definition of the universe, the interpretation of cosmology and astronomy based on the inventive NMPSA-based interpretation of the R&D findings near absolute zero temperatures. The overall findings leads to the inventive postulation that the zero degree absolute temperature is the transition-point for matter having atomic and molecular structures to degrade by collapsing orbital electrons into their atomic nuclei to form a new matter named by the inventor the extreme dense matter (EDM) having proton, electron, neutrino and mini-neutrino particles densely packed together stable at any size only at zero and below degrees of absolute temperatures. The invention therefore defines a universe to be an open space hosting matter having sufficient number of stars in it to keep both its space and its matter above zero degree absolute temperatures and the open space hosting matter at zero and below degrees absolute temperatures is outside the universe, where the matter having atomic and molecular structures cannot exist and EDM bodies are stable and growing in size by agglomeration collecting surrounding EDM and elementary particles. Since EDM heavenly bodies are so dense, they are not penetrable by neutrino and even by mini-neutrino particles. Once entering a universe, under constant bombardment of the atmospheric energetic neutrino and mini-neutrino particles, EDM will start and constantly undergo nuclear reactions only on their surface to emit hydrogen, helium and elementary particles to become the densest stars, namely, the neutron stars, the pulsar stars, and the black holes. Constantly emitting energetic particles these stars should have strong antigravitational force contrarily to the teaching of the scientific community that they have very strong gravitational force. The invention further teaches that a regular bright star is made of a neutron or a pulsar star, which constantly emits hydrogen and helium gases throwing them to a faraway place, where they gradually gather to form a large hollow ball-shaped out-layer, which gets denser and brighter with time from the constant nuclear reactions of the neutron or pulsar star at its center. The invention further teaches that the inner surface of the out-layer of a mature regular bright star will reach the critical temperatures to start nuclear reactions to form elements heavier than helium making the out-layer harder and harder for the gases produced by the nuclear reactions of the neutron or pulsar star at the center to dissolve in and to penetrate through, thus, building up the inner gas pressure to eventually lead to a violently expanding of a regular bright star turning to a red giant star, exploding to shedding part of its out-layer to become a white dwarf, or shedding all its out-layer to re-born a smaller neutron or pulsar star. A regular bright star in its lifetime begins with having strong antigravity gradually turning to a gravity star with its gravitational force getting stronger upon aging. Therefore, contrary to general belief, a regular bright star does not have a constant strength of gravitational force in its lifetime. The invention also teaches that a red giant, a white dwarf, or a brown dwarf star has an out-layer of matter having atomic and molecular structures and a neutron or a pulsar star at its center. A pulsar is fast rotating emitting most of its elementary particles on a thin plane at an angle along its rotating direction where its antigravity force is the strongest. Therefore, a regular bright star having a pulsar at its center has an antigravitational force concentrated on a thin plane around the star to support the pseudo-steady-state orbital motion of its planets. The invention therefore teaches that only the stars having a pulsar inside them can have planets such as our Sun. The invention further teaches that a galaxy having billions of stars produces a neutrino and mini-neutrino galaxy-wind blowing out of it and when all galaxy winds meet, they create hurricane-like neutrino and mini-neutrino-particle wind to push all the stars of a galaxy moving like a hurricane cloud known to be spiral galaxies. Since most stars inside a galaxy are far apart from one another, the invention teaches that the galaxy wind dominantly controls the motions of the stars in galaxies not the gravitational force of its stars and planets as taught by the scientific community.

The inventive NMPSA is beautifully logical consistent and coherent as a whole to be a self-sufficient science with its technological applications. For example, the findings of both the source of the charge energy of both proton and electron and the zero-degree absolute temperature to be the transition point for matter having atomic and molecular structure to degrade to EDM alone have logically led to the discovery of the entire advanced NMPSA. The constant collision interactions between the atmospheric energetic neutrino and mini-neutrino particles with matter particles to produce both matter itself and universal phenomena logically should constantly produce heat energy leading to the realization why the center of planets is so hot and why there are volcanic activities. In addition, the realization that atmospheric neutrino and mini-neutrino particles play important roles in producing charge energy and electricity will significantly advance Earth science and space science. According to the advanced NMPSA, our Sun has a pulsar at its center using its concentrated antigravitational force to support all planets' pseudo-steady-state orbital motions. It is already known that the rotation speeds of some pulsar stars slow down with time. Therefore, there is a real possibility for the rotation speed of the pulsar star inside our Sun to gradually or even suddenly slow down to reduce its antigravitational force around it, which may result in significant change of the orbital motions of all planets. Therefore, our Sun does not have the stability of millions of years as predicted by the scientific community based on their MTP knowledge. The global warming problem alone may be solvable by replacing fossil fuel with clean energy but not the above-mentioned scientific problem. The development of a mechanical way to drive the Earth closer or farther away from the Sun may be a more common scientific solution for solving the weather-related problems of the Earth. The invention teaches that matter having atomic and molecular structures needs to breath the atmospheric neutrino and mini-neutrino particles to exist. Therefore, traveling in space needs to study both long turn human survivability and matter stability in deep space, where has much diluted atmospheric neutrino and mini-neutrino particles than around the Earth.

In summary, the invention regards to the teaching of an advanced narrowly-defined mechanical-physics-based science and its technological applications. It can be taught using text books, Internet, and other electronical devises.

What is claimed is:

1. The teaching of an advanced mechanical-physics-based science and its applications obeying the narrow definition of science using experimental methods to discover nature laws and to prove them correct or wrong, together with its currently accepted knowledge, having a scientific scope capable of interpreting everything detectable experimentally with all interpretations and technological applications logically consistently coherently related to one another as a whole to become a self-sufficient science itself comprises the following four size-range groups of elementary matter particles to produce all compositions of matter and their phenomena: the single uncharged proton particles; the single uncharged electron particles; the neutrino particles; and the mini-size neutrino particles, all constantly produced and emitted by the nuclear reactions of all stars.

2. The teaching of claim 1 wherein a proton constantly carrying charge energy consists of a single uncharged proton particle surrounded by a dense cloud of neutrino and mini-size neutrino particles.

3. The teaching of claim 1, wherein an electron constantly carrying charge energy consists of a single uncharged electron particle surrounded by a dense cloud of neutrino and mini-size neutrino particles.

4. The teaching of claim 1 wherein a universe is an open space hosting matter consisting of sufficient number of stars to keep it above zero-degree absolute temperatures leaving the open space outside the universe hosting matter at zero and below degrees absolute temperatures to be outside the universe.

5. The teaching of claim 1, 2, or 3 wherein matter having atomic and molecular structures is made of protons and electrons consisting of all four size-range groups of elemental matter particles.

6. The teaching of claim 1, 2, or 3 wherein extremely-dense matter consists of all four size-range elementary matter particles closely packed together.

7. The teaching of claim 2, 3, or 4 wherein the zero-degree absolute temperature is the transition point for matter having atomic and molecular structures existing inside the universe to degrade by collapsing orbital electrons into atomic nuclei to form the extremely-dense matter stable outside the universe only.

8. The teaching of claim 1 or 4 wherein an atmospheric energetic neutrino and mini-neutrino particles takes up all space inside the universe to collide interacting with matter to produce matter itself and universal phenomena.

9. The teaching of claim 8 wherein gravitational force is the pushing force produced by the winds of the atmospheric neutrino and mini-neutrino particles constantly blowing into heavenly bodies comprising of matter having atomic and molecular structures.

10. The teaching of claim 4 wherein inside universe a galaxy hosting billions of stars producing its galaxy wind of neutrino and mini-neutrino particles and the combined winds of many galaxies are the dominate universal force to shape up galaxies such as the formation of spiral galaxies and to control stars' motions in galaxies.

11. The teaching of claim 4 wherein the heavenly bodies of the extremely-dense matter outside the universe entering the universe becoming unstable undergoing nuclear reactions on their surface turn them into the densest stars already known to be black holes, neutron stars, and pulsars all having strong antigravitational force not strong gravity.

12. The teaching of claim 1, 2, or 3 wherein in the universe light is made of neutrino and mini-neutrino particles inside both matter having atomic and molecular structures and extremely-dense matter by collision interactions of matter particles.

13. The teaching of claim 11 wherein a regular bright star consists of a neutron star or a pulsar star at its center having a large ball-shaped hollow out-layer made of matter having atomic and molecular structures.

14. The teaching of claim 13 wherein red giant, white dwarf, and brown dwarf stars consist of a neutron or a pulsar star at their center having an out-layer of matter having atomic and molecular structures.

15. The teaching of claim 13 or 14 wherein only the stars having a pulsar in their center have planets.
